(19) United States
(12) Patent Application Publication
(10) Pub. No.: US 2023/0290625 A1
(43) Pub. Date: Sep. 14, 2023

(54) SAMPLE SUPPORT, IONIZATION METHOD, AND MASS SPECTROMETRY METHOD

(71) Applicant: HAMAMATSU PHOTONICS K.K., Hamamatsu-shi, Shizuoka (JP)

(72) Inventors: Takamasa IKEDA, Hamamatsu-shi, Shizuoka (JP); Masahiro KOTANI, Hamamatsu-shi, Shizuoka (JP); Akira TASHIRO, Hamamatsu-shi, Shizuoka (JP); Takayuki OHMURA, Hamamatsu-shi, Shizuoka (JP)

(73) Assignee: HAMAMATSU PHOTONICS K.K., Hamamatsu-shi, Shizuoka (JP)

(21) Appl. No.: 18/018,314

(22) PCT Filed: Jun. 1, 2021
(86) PCT No.: PCT/JP2021/020813

§ 371 Date: Jan. 27, 2023

(30) Foreign Application Priority Data
Sep. 4, 2020 (JP) 2020-148904

(51) Int. Cl. H01J 49/04; H01J 49/16; H01J 49/00

(52) U.S. Cl. CPC H01J 49/0409; H01J 49/165; H01J 49/0031; H01J 49/26

(57) ABSTRACT

A sample support is a sample support for ionizing a sample. The sample support includes a substrate that includes a first surface having electrical insulating property, a second surface opposite to the first surface, and an irregular porous structure that opens to at least the first surface.

### TECHNICAL FIELD

The present disclosure relates to a sample support, ionization method, and mass spectrometry method.

### BACKGROUND ART

Desorption electrospray ionization (DESI) is known as a method for ionizing a sample such as a biological sample in order to perform mass spectrometry or the like (for example, see Patent Document 1). The desorption electrospray ionization is a method in which charged microdroplets are irradiated onto a sample to desorb and ionize the sample.

### CITATION LIST

### Patent Document

Patent Document 1: Japanese Unexamined Patent Application Publication No. 2007-165116

### SUMMARY OF INVENTION

### Technical Problem

In the desorption electrospray ionization method, for example, in order to improve signal intensity (sensitivity) in the mass spectrometry, it is required to appropriately ionize a component of a sample.

Therefore, an object of the present disclosure is to provide a sample support and an ionization method capable of suitably ionizing a component of a sample, and a mass spectrometry method capable of improving signal intensity.

### Solution to Problem

A sample support according to one aspect of the present disclosure is a sample support for ionizing a sample. The sample support includes a substrate that includes a first surface having electrical insulating property, a second surface opposite to the first surface, and an irregular porous structure that opens to at least the first surface.

In the sample support, the first surface of the substrate has electrical insulation property. Thus, desorption and ionization of the sample can be suitably performed by a method of irradiating the sample transferred to the first surface with charged microdroplets (desorption electrospray ionization method). Further, an irregular porous structure opened to the first surface is formed in the substrate. Accordingly, the sample transferred to the first surface can be appropriately diffused into the porous structure, and the amount of the sample remaining on the first surface can be appropriately adjusted. As described above, according to the sample support, the component of the sample can be suitably ionized.

The porous structure may be formed by an aggregate of a plurality of particles. Accordingly, the sample transferred to the first surface can be appropriately retained on the surface of each particle constituting the aggregate.

The first surface may be provided with an electrically insulating coating. The porous structure may be formed by an aggregate of a plurality of particles made of a metal. In this case, since the first surface of the substrate can be made electrically insulating by the insulating coating, it is possible to use a substrate formed of a material having conductivity. That is, the degree of freedom of selection of the substrate material can be improved.

The particles may be made of glass, a metal oxide, or an insulating coated metal. Alternatively, the particles may be glass beads. In this case, the substrate having the irregular porous structure described above can be suitably obtained at low cost.

The porous structure may be formed so as to communicate the first surface and the second surface. In this case, the surplus component of the sample transferred to the first surface can be more suitably released from a first surface side to a second surface side.

An ionization method according to another aspect of the present disclosure includes: a first step of preparing a sample support that includes a substrate including a first surface having an electrical insulating property, a second surface opposite to the first surface, and an irregular porous structure that opens to at least the first surface; a second step of transferring a sample to the first surface; a third step of ionizing the transferred component of the sample by irradiating the first surface with a charged microdroplet, and sucking the ionized component.

In the ionization method described above, since the first surface of the substrate of the sample support is an electrically insulating member, even if the microdroplet irradiation unit to which a high voltage is applied is brought close to the first surface, for example, the occurrence of discharge between the microdroplet irradiation unit and the sample support is suppressed. In addition, as described above, since the substrate 2 has an irregular porous structure, the amount of sample remaining on the first surface may be appropriately adjusted. Therefore, according to this ionization method, the component of the sample transferred to the first surface can be suitably ionized by bringing the microdroplet irradiation unit close to the first surface and irradiating the first surface with the charged microdroplet.

The porous structure may be formed by an aggregate of a plurality of particles, and the component of the sample may be held on a surface of the particle in the second step. Accordingly, the sample transferred to the first surface can be appropriately retained on the surface of the aggregate. As a result, in the third step, the component of the sample can be suitably ionized.

In the ionization method, in the third step, an irradiated area of the charged microdroplets may be relatively moved with respect to the first surface. In the component of the sample remaining on a first surface side of the substrate, position information of the sample (two-dimensional distribution information of molecules constituting the sample) is maintained. Therefore, by relatively moving the irradiated area of the charged microdroplet with respect to the first surface, it is possible to ionize the component of the sample while maintaining the position information of the sample. This makes it possible to image the two-dimensional distribution of the molecules constituting the sample in the subsequent step of detecting the ionized component. Furthermore, since the microdroplet irradiation unit can be brought close to the first surface as described above, it is possible to suppress the enlargement of the irradiated area of the charged microdroplet. This makes it possible to image the two-dimensional distribution of the molecules constituting the sample with high resolution in the subsequent step of detecting the ionized component.

A mass spectrometry method according to still another aspect of the present disclosure includes the first step, the second step, and the third step of the above-described ionization method, and a fourth step of detecting the component ionized in the third step.

In the mass spectrometry method, as described above, since the component of the sample is suitably ionized by the irradiation of the charged microdroplets, it is possible to improve the signal intensity when detecting the ionized component.

### Advantageous Effects of Invention

According to the present disclosure, it is possible to provide a sample support and an ionization method capable of suitably ionizing a component of a sample, and a mass spectrometry method capable of improving signal intensity.

### BRIEF DESCRIPTION OF DRAWINGS

FIG. 1 is a perspective view showing a sample support according to an embodiment.

FIG. 2 is an enlarged image of a region A shown in FIG. 1.

FIG. 3 is a diagram showing the diameter of a joint and the diameter of beads in a bead aggregate.

FIG. 4 is a diagram illustrating a second step in a mass spectrometry method according to an embodiment.

FIG. 5 is a configuration diagram of a mass spectrometer that performs a mass spectrometry method according to an embodiment.

### DESCRIPTION OF EMBODIMENTS

Hereinafter, embodiments of the present invention will be described in detail with reference to the drawings. In the drawings, the same or corresponding portions are denoted by the same reference numerals, and redundant description is omitted.

[Sample Support]

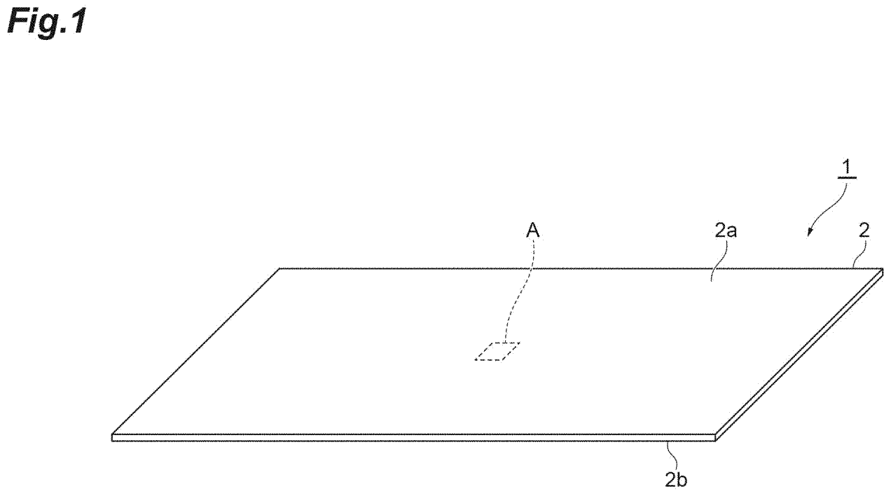

As shown in FIG. 1, the sample support 1 includes a substrate 2. As an example, the substrate 2 is formed in a rectangular plate shape. The substrate 2 has a first surface 2a and a second surface 2b opposite to the first surface 2a. The first surface 2a is electrically insulating. In the present embodiment, the substrate 2 is an electrically insulating member. Therefore, not only the first surface 2a but also the entire substrate 2 has electrical insulation property. The thickness (distance from the first surface 2a to the second surface 2b) of the substrates 2 is, for example, about 100 μm to 1500 μm.

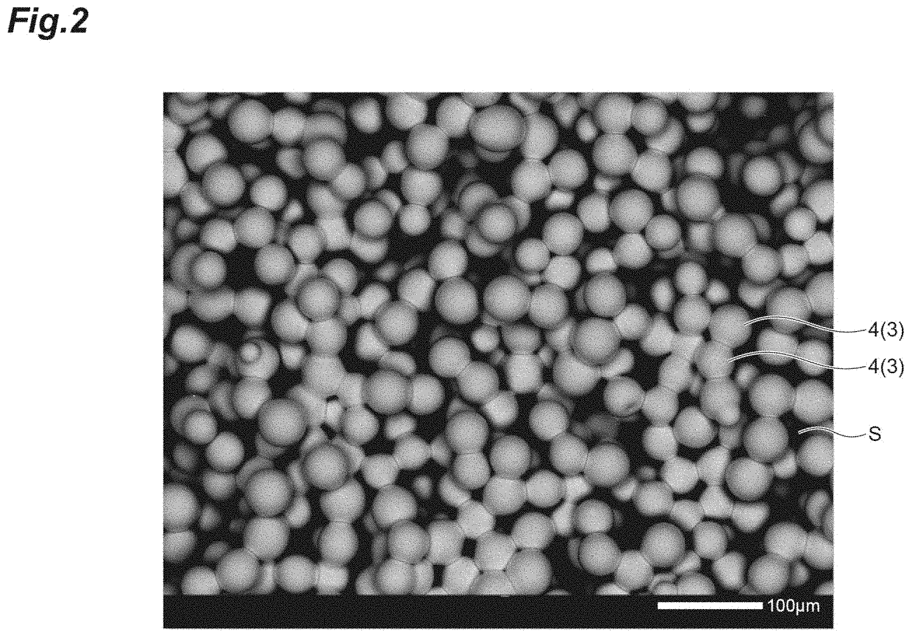

As shown in FIG. 2, the substrate 2 is formed with an irregular porous structure 3 which opens to the first surface 2a. The irregular porous structure is, for example, a structure in which gaps (fine pores) extend in an irregular direction and are irregularly distributed in three dimensions. Examples of the irregular porous structure include a structure that enters the substrate 2 from one inlet (opening) on the first surface 2a side and branches into a plurality of paths, and a structure that enters the substrate 2 from a plurality of inlets (openings) on the first surface 2a side and merges into one path. On the other hand, for example, a structure in which a plurality of pores extending along the thickness direction of the substrate 2 from the first surface 2a to the second surface 2b are provided as main pores (that is, a regular structure constituted by pores extending mainly in one direction) is not included in the irregular porous structure.

The porous structure 3 is formed of, for example, an aggregate of a plurality of particles. The aggregate of a plurality of particles is a structure in which a plurality of particles are collected so as to be in contact with each other. An example of the aggregate of a plurality of particles is a structure in which a plurality of particles are adhered or bonded to each other. In the present embodiment, the porous structure 3 is a bead aggregate (aggregate) formed by bonding a plurality of beads 4 to each other. That is, the substrate 2 is constituted by a bead aggregate (porous structure 3) obtained by bonding a plurality of beads 4 to each other and forming the beads 4 into a rectangular plate shape. The porous structure 3 has a portion occupied by the plurality of beads 4 and gaps S between the plurality of beads 4.

In the present embodiment, the beads 4 are glass beads. In this case, the bead aggregate is, for example, a sintered body of a plurality of glass beads (beads 4). In the present embodiment, entire of the substrate 2 is constituted by the porous structure 3. That is, the porous structure 3 is formed over the entire region from the first surface 2a to the second surface 2b of the substrate 2. Thus, the porous structure 3 is formed so as to communicate the first surface 2a and the second surface 2b.

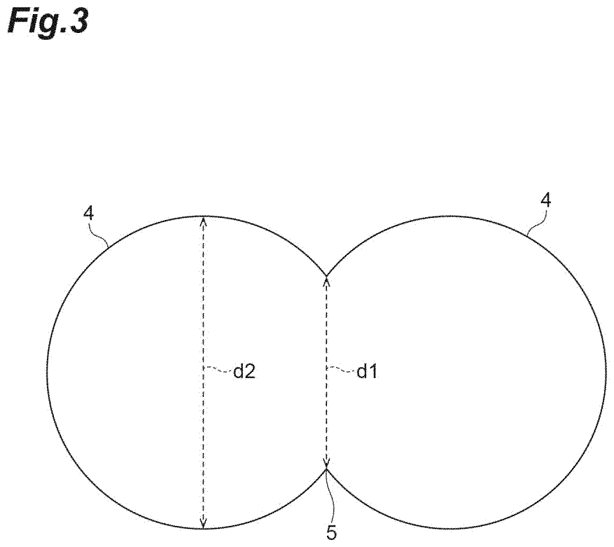

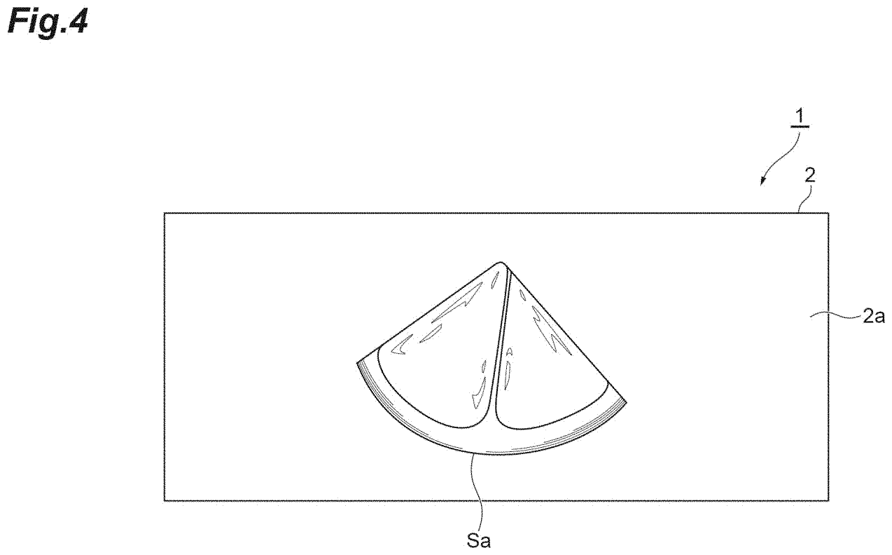

As shown in FIG. 3, the beads 4 adjacent to each other are joined (fused) to each other. The substrate 2 has rigidity to such an extent that second step (transfer of sample Sa (see FIG. 4)) of an ionization method described later can be performed. If the rigidity of the substrate 2 is insufficient, the substrate 2 may be damaged when the sample Sa is pressed against the first surface 2a or when the sample Sa is peeled off from the first surface 2a. Therefore, the substrate 2 has rigidity (i.e., rigidity to the extent that the substrate 2 is not damaged by the transfer of the sample Sa) that can withstand the transfer of the sample Sa (see FIG. 4) (i.e., an operation of pressing the sample Sa against the first surface 2a and an operation of peeling the sample Sa from the first surface 2a). In the present embodiment, in order to secure such rigidity, the average diameter of the joint 5 between the beads 4 adjacent to each other (the average of the diameter d1 of each joint 5) is 1/10 (one tenth) or more of the average diameter of the beads 4 (the average of the diameter d2 of each bead 4) and less than the average diameter of the beads 4.

[Ionization Method and Mass Spectrometry Method]

An ionization method and a mass spectrometry method using the sample support 1 will be described. First, the above-described sample support 1 is prepared as a sample support for ionization of a sample (first step). The sample support 1 may be prepared by being manufactured by a practitioner who carries out the ionization method and the mass spectrometry method, or may be prepared by being acquired from a manufacturer, a seller, or the like of the sample support 1.

Subsequently, as shown in FIG. 4, the sample Sa is transferred to the first surface 2a of the substrate 2 (second step). In the example of FIG. 4, the sample Sa is a section of a fruit (lemon). For example, by pressing the sample Sa against the first surface 2a of the substrate 2, a part of the sample Sa is attached onto the first surface 2a.

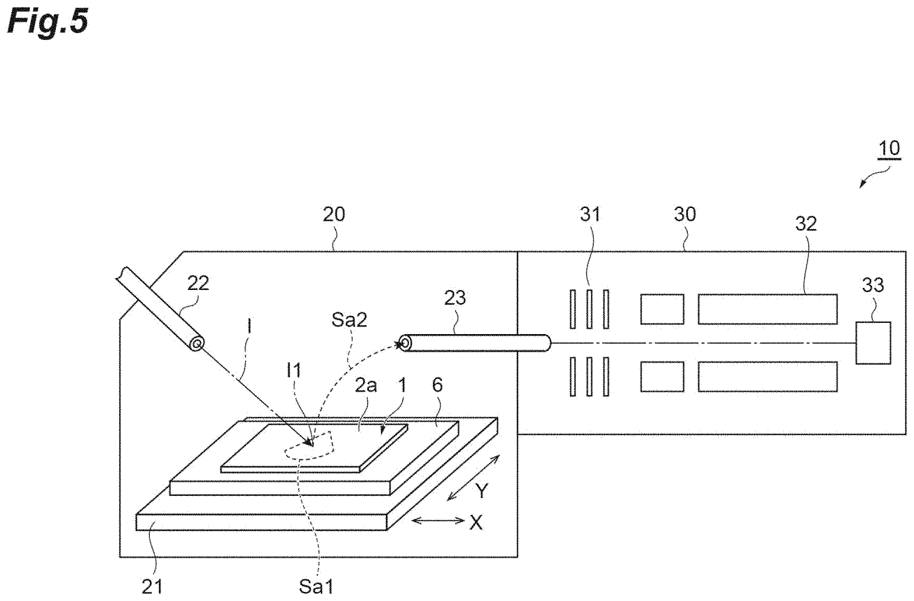

Subsequently, as shown in FIG. 5, the slide glass 6 and the sample support 1 are placed on the stage 21 in the ionization chamber 20 of the mass spectrometer 10. Subsequently, the component 2a on the first surface Sa1 is ionized by irradiating a region (hereinafter referred to as a “target region”) including a region where the transferred sample Sa exists in the first surface 2a of the substrate 2 with the charged microdroplets I, and a sample ion Sa2 which is the ionized component is sucked (third step). In the present embodiment, for example, by moving the stage 21 in the X-axis direction and the Y-axis direction, the irradiated area I1 of the charged microdroplets I is relatively moved with respect to the target region (that is, the target region is scanned with the charged microdroplets I). The above-described first step, second step, and third step correspond to an ionization method using the sample support 1 (in the present embodiment, desorption electrospray ionization method).

In the ionizing chamber 20, charged microdroplets I are ejected from the nozzle 22, and the sample ion Sa2 is sucked from the suction port of the ion transport tube 23. The nozzle 22 has a double-cylinder structure. The solvent is guided into the inner cylinder of the nozzle 22 in a state where a high voltage is applied. As a result, an offset charge is applied to the solvent that has reached the tip of the nozzle 22. Nebulizer gas is guided to the outer cylinder of the nozzle 22. As a result, the solvent is sprayed as microdroplets, and solvent ions generated during the evaporation of the solvent are emitted as charged microdroplets I.

The sample ion Sa2 sucked from the suction port of the ion transport tube 23 is transported into the mass spectrometry chamber 30 by the ion transport tube 23. The inside of the mass spectrometry chamber 30 is under a condition of a high vacuum atmosphere (an atmosphere with a vacuum degree of 10⁻⁴ Torr or less). In the mass spectrometry chamber 30, a sample ion Sa2 is converged by an ion optical system 31 and introduced into a quadrupole mass filter 32 to which a high-frequency voltage is applied. When the sample ion Sa2 is introduced into the quadrupole mass filter 32 to which a high-frequency voltage is applied, ions having a mass number determined by the frequencies of the high-frequency voltage are selectively passed through the quadrupole mass filter 32, and the passed ions are detected by the detector 33 (fourth step). By scanning the frequency of the high-frequency voltage applied to the quadrupole mass filter 32, the mass number of ions reaching the detector 33 is sequentially changed to obtain a mass spectrum in a predetermined mass range. In the present embodiment, ions are detected by the detector 33 so as to correspond to the position of the irradiated area I1 of the charged microdroplets I, and the two-dimensional distribution of molecules constituting the sample Sa is imaged. The first step, the second step, the third step, and the fourth step correspond to a mass spectrometry method using the sample support 1.

[Effect]

In the sample support 1 described above, the first surface 2a of the substrate 2 has electrical insulation property. Thus, the sample Sa transferred to the first surface 2a can be suitably desorbed and ionized by a method of irradiating the sample Sa with charged microdroplets (desorbed electrospray ionization method). Further, the substrate 2 is formed with the irregular porous structure 3 opening to the first surface 2a. Accordingly, the sample Sa transferred to the first surface 2a can be appropriately diffused into the porous structure 3, and the amount of the sample Sa remaining on the first surface 2a can be appropriately adjusted. As described above, according to the sample support 1, the component of the sample Sa can be suitably ionized.

The porous structure 3 is a bead aggregate (aggregate) formed by bonding a plurality of beads 4 (particles) to each other. Accordingly, the component of the sample Sa transferred to the first surface 2a can be appropriately retained on the surfaces of the beads 4 constituting the bead aggregate. In addition, in the present embodiment, the component of the sample Sa can be appropriately retained on the joint 5 between the beads 4 (for example, a recessed portion formed by the beads 4 adjacent to each other).

Further, the particles (beads 4 in the present embodiment) constituting the porous structure 3 are substantially spherical, and the average diameter of the joint 5 of the beads 4 in the bead aggregate (average diameter d1 of each joint 5 (see FIG. 3)) is 1/10 (one tenth) or more of the average diameter of the beads 4 (average diameter d2 of each bead 4 (see FIG. 3)) and less than the average diameter of the beads 4. Accordingly, the rigidity of the joint 5 in the bead aggregate can be secured, and the substrate strength (rigidity) capable of withstanding the transfer of the sample Sa to the first surface 2a can be secured. In addition, by securing the rigidity of the substrate 2 in this manner, it is possible to dispense with a frame member or the like for supporting the substrate 2. In order to secure the rigidity of the substrate 2, it is not essential that the particles are bonded to each other so as to satisfy the above conditions. For example, when ceramic particles (metal oxide) are used as the particles constituting the porous structure 3, sufficient rigidity of the substrate 2 can be ensured even if the particles are not bonded to each other so as to satisfy the above conditions.

The beads 4 are glass beads. In this case, the substrate 2 having the irregular porous structure 3 described above can be suitably obtained at low cost.

The porous structure 3 is formed so as to communicate the first surface 2a and the second surface 2b. In this case, the surplus component of the sample Sa transferred to the first surface 2a can be more suitably released from the first surface 2a side to the second surface 2b side. Accordingly, it is possible to more appropriately adjust the amount of sample Sa remaining on the first surface 2a.

In addition, in the ionization method (first step to third step) using the sample support 1, since the first surface 2a of the substrate 2 of the sample support 1 is an electrically insulating member, even if the nozzle 22 as a microdroplet irradiation unit to which a high voltage is applied is brought close to the first surface 2a, for example, the occurrence of discharge between the nozzle 22 and the sample support 1 is suppressed. In addition, as described above, since the substrate 2 has the irregular porous structure 3, the amount of the sample Sa remaining on the first surface 2a can be appropriately adjusted. Therefore, according to this ionization method, by bringing the nozzle 22 close to the first surface 2a and irradiating the first surface 2a with the charged microdroplets, the components of the sample Sa transferred to the first surface 2a can be suitably ionized.

The porous structure 3 is a bead aggregate formed by bonding a plurality of beads 4 to each other, and in the second step, the components of the sample Sa are held on the surfaces of the beads 4. Accordingly, the sample Sa transferred to the first surface 2a can be appropriately retained on the surface of the bead aggregate (porous structure 3). As a result, in the third step, the component of the sample Sa can be suitably ionized. As described above, in the present embodiment, the component of the sample Sa can also be appropriately retained on the joint 5 between the beads 4.

In the third step of the ionization method described above, the irradiated area I1 of the charged microdroplets I is relatively moved with respect to the first surface. In the component of the sample Sa remaining on the first surface 2a side of the substrate 2, position information of the sample Sa (two-dimensional distribution information of molecules constituting the sample Sa) is maintained. Therefore, by relatively moving the irradiated area I1 of the charged microdroplets I with respect to the first surface 2a (target region), it is possible to ionize the component of the sample Sa while maintaining the positional information of the sample Sa. Thus, in the subsequent step of detecting the sample ion Sa2, the two-dimensional distribution of molecules constituting the sample Sa can be imaged. Further, since the nozzle 22 can be brought close to the first surface 2a as described above, the irradiated area I1 of the charged microdroplets I can be suppressed from expanding. Thus, in the subsequent step of detecting the sample ion Sa2, the two-dimensional distribution of molecules constituting the sample Sa can be imaged with high resolution.

In addition, in the mass spectrometry method using the sample support 1, as described above, since the component of the sample Sa is suitably ionized by the irradiation of the charged microdroplets I, it is possible to improve the signal intensity when detecting the sample ion Sa2.

[Modification]

The present disclosure is not limited to the embodiments described above. For example, although the sample support 1 includes only the substrate 2 in the above-described embodiment, the sample support 1 may include a member other than the substrate 2. For example, a support member (a frame or the like) for supporting the substrate 2 may be provided in a portion (for example, a corner portion or the like) of the substrate 2.

In addition, the sample Sa is not limited to the section of the fruit (lemon) exemplified in the above embodiment. The sample Sa may have a flat surface or may have an uneven surface. In addition, the sample Sa may be other than fruits, and may be, for example, leaves of plants. In this case, imaging mass spectrometry of the surface (veins) of the leave can be performed by transferring the components of the surface of the leave as the sample Sa to the first surface 2a.

In addition, in the above-described embodiment, the entire substrate 2 is configured by the porous structure 3 which is a bead aggregate, but the porous structure 3 may be formed in a part of the substrate 2. For example, the porous structure 3 may be formed only in a region of a central portion (a partial region of the first surface 2a) defined as a measurement region for transferring the sample Sa on the substrate 2, and the porous structure 3 may not be formed in the other portion of the substrate 2. Further, the porous structure 3 may not be formed over the entire region from the first surface 2a to the second surface 2b. That is, the porous structure 3 may be open to at least the first surface 2a, and may not be open to the second surface 2b. For example, the substrate 2 may be constituted by a flat plate and a porous structure provided on the plate. As an example, the substrate 2 may be constituted by a glass plate and a glass bead aggregate (porous structure) provided on the glass plate.

In the above-described embodiment, the first surface 2a has an electrical insulating property because the substrate 2 is formed of an insulating material. However, the substrate 2 may be formed of a conductive material. In this case, an electrically insulating coating may be applied to the first surface 2a of the substrate 2 to realize a configuration in which the first surface 2a has electrical insulation property. Since the first surface 2a of the substrate 2 can be made electrically insulating by applying such an insulating coating, it is possible to use the substrate 2 formed of a material having conductivity. For example, in this case, the porous structure 3 may be formed by an aggregate of a plurality of particles made of metal. Thus, in the case where an electrically insulating coating is provided, the degree of freedom of selection of the substrate material can be improved.

In addition, as a material of the particles constituting the porous structure 3, for example, glass, metal oxide (for example, alumina or the like), an insulation-coated metal, or the like may be used. The particles constituting the porous structure 3 are not limited to substantially spherical beads, and may have a shape other than a substantially spherical shape.

### REFERENCE SIGNS LIST

1: sample support, 2: substrate, 2a: first surface, 2b: second 5 surface, 3: porous structure, 4: beads (particles), 5: joint, Sa: sample, Sa2: sample ion (ionized component).

1: A sample support for ionizing a sample, comprising:
a substrate that includes:
a first surface having electrical insulating property;
a second surface opposite to the first surface; and
an irregular porous structure that opens to at least the first surface.

2: The sample support according to claim 1, wherein
the porous structure is formed by an aggregate of a plurality of particles.

3: The sample support according to claim 1, wherein
the first surface is provided with an electrically insulating coating.

4: The sample support according to claim 3, wherein
the porous structure is formed by an aggregate of a plurality of particles made of metal.

5: The sample support according to claim 2, wherein
the particles are made of glass, a metal oxide, or an insulation-coated metal.

6: The sample support according to claim 5, wherein
the particles are glass beads.

7: The sample support according to claim 1, wherein
the porous structure is formed so as to communicate the first surface and the second surface.

8: An ionization method including:
a first step of preparing a sample support that includes a substrate including a first surface having an electrical insulating property, a second surface opposite to the first surface, and an irregular porous structure that opens to at least the first surface;
a second step of transferring a sample to the first surface; and
a third step of ionizing the transferred component of the sample by irradiating the first surface with a charged microdroplet, and sucking the ionized component.

9: The ionization method according to claim 8, wherein
the porous structure is formed by an aggregate of a plurality of particles, and
in the second step, the component of the sample is held on a surface of the particle.

10: The ionization method according to claim 8, wherein
in the third step, an irradiated area of the charged microdroplets is relatively moved with respect to the first surface.

11: A mass spectrometry method including:
a first step of preparing a sample support that includes a substrate including a first surface having an electrical insulating property, a second surface opposite to the first surface, and an irregular porous structure that opens to at least the first surface;
a second step of transferring a sample to the first surface;
a third step of ionizing the transferred component of the sample by irradiating the first surface with a charged microdroplet, and sucking the ionized component; and
a fourth step of detecting the component ionized in the third step.
